(19) United States
(12) Patent Application Publication
(10) Pub. No.: US 2026/0212745 A1
(43) Pub. Date: Jul. 23, 2026

(54) SENSING DEVICE FOR INTEGRATED IMAGE CAPTURE OF AN OBJECT AND RELATED INTRUSION DETECTION SYSTEMS

(71) Applicants: Kevin Russell, Old Lyme, CT (US); Brandon Joseph McGinley, Conway, AZ (US); Troy Russell, Old Lyme, CT (US); Bryan Ritter, Wolcott, NY (US)

(72) Inventors: Kevin Russell, Old Lyme, CT (US); Brandon Joseph McGinley, Conway, AZ (US); Troy Russell, Old Lyme, CT (US); Bryan Ritter, Wolcott, NY (US)

(21) Appl. No.: 19/425,917

(22) Filed: Dec. 18, 2025

Related U.S. Application Data
(60) Provisional application No. 63/736,236, filed on Dec. 19, 2024.

(51) Int. Cl. G08B 21/02; G06V 10/82; G06V 20/54; G08B 7/06

(52) U.S. Cl. CPC G08B 21/02; G06V 10/82; G06V 20/54; G08B 7/06

(57) ABSTRACT

A sensing device for integrated image capture of stationary or moving objects in roadway intrusion detection systems comprises a camera and central processing unit configured with artificial intelligence to capture images within a specified area, calculate mass and motion of objects, and predict trajectories. The CPU employs neural networks trained on custom models for vehicle detection and classification without requiring internet connectivity. When objects are predicted to enter protected areas such as work zones with emergency, construction, or maintenance personnel, the system generates voltage signal outputs to activate audible, visual, and haptic alert indicators. The device features a single housing with monocular camera, CPU, and wireless communication, mountable on fixed locations or vehicles, functioning in both stationary and mobile applications. The system is expandable with additional cameras for stereoscopic vision or doppler radar for enhanced measurements, determines safe traffic patterns by analyzing direction, lane position, and speed, provides staged warnings at multiple distance thresholds, detects irregular traffic patterns, collects traffic data, operates in drone-mounted aerial configurations, and recognizes changes in safety equipment patterns to alert workers of compromised work zone perimeters.

This application claims the benefit of U.S. provisional application No. 63/736,236 filed on Dec. 19, 2024, which is incorporated herein in its entirety by reference.

### FIELD OF THE INVENTION

This invention relates to a sensing device for integrated image capture of stationary or moving objects for use in an intrusion detection system for roadways. The invention comprises a camera-based system with artificial intelligence that detects approaching vehicles, predicts trajectories, and activates multiple alert mechanisms to protect workers and drivers in work zones and emergency situations.

### BACKGROUND OF THE INVENTION

Currently, there are many injuries and deaths occurring in work zone areas and on streets and highways, involving emergency vehicles stopped on the roadside.

In general, the invention system is a warning system designed to detect moving objects entering a specified area. The system can also detect stationary objects in the specified area as well.

Most intrusion detection systems require active sensors which use ultrasonic or LIDAR technology to detect objects and distance. These sensors do not accurately classify the object as a vehicle and heavy traffic situations cause false positive identifications. They are also limited in distance and partial occlusion.

More particularly, the invention system is designed to detect moving vehicles entering a specified area that could potentially cause harm to persons or property in the specified area. These systems are designed primarily for work zone areas.

However, the invention system is also used for emergency vehicles stopped on streets and highways. In this embodiment the system is able to pre-emptively warn the individuals, in the path of these moving objects, if a vehicle or vehicles have entered the space in which they are working prior to reaching the actual work zone.

The prior art does not disclose a detection system for approaching motor vehicles comprising a camera, central processing unit device, artificial intelligence, visual and audible alert indicators to send out alerts to warn workers/driver of impending collisions. The invention detection system does not use active sensors and can be placed on signs, vehicles or anywhere in a construction and/or emergency zone.

U.S. Pat. No. 11,117,514 to White discloses a motor vehicle visual and audio proximity warning system. The White system requires an internet connection and active sensors to detect objects/vehicles motion. The present invention computes motion locally on-site and in real-time and advantageously, does not require an internet connection.

The present invention provides numerous advantages over existing detection systems:

No Active Sensor Requirements: Unlike systems using ultrasonic or LIDAR sensors that emit active signals, this invention operates as a passive sensor using only ambient light. Passive operation eliminates issues with signal interference, cross-talk between multiple sensors, and false positives caused by environmental reflections.

No Internet Dependency: All AI processing occurs locally on the device without requiring internet connectivity or cloud services. Local processing provides faster response, eliminates network dependency, maintains operation in areas with poor connectivity, and enhances privacy since captured images are not transmitted externally.

Custom AI for Roadway Applications: The neural network is trained specifically for roadway safety rather than using general-purpose object detection. This specialization provides higher accuracy, lower false positive rates, and better performance on safety-relevant objects compared to generic AI systems.

Predictive Warnings: Rather than simply detecting when objects have entered the protected area (reactive response), the system predicts future trajectories and warns before intrusions occur (proactive prevention). This predictive capability provides critical extra seconds for personnel to reach safety.

Multi-Platform Versatility: The device functions effectively in fixed, mobile, and aerial deployments, providing flexibility not available in systems designed for only one deployment mode. The ability to function on moving platforms is particularly novel and valuable for emergency vehicle protection.

Comprehensive Irt Options: The multi-modal alert system with audible, visual, haptic, and remote notification ensures warnings reach personnel through multiple sensory channels, maximizing safety effectiveness.

Traffic Pattern Understanding: Beyond simple object detection, the AI understands traffic patterns, lane assignments, and safe versus unsafe vehicle behaviors, enabling intelligent discrimination between harmless traffic and genuine threats.

Expandable Architecture: The modular design supporting additional cameras, radar units, and other sensors enables system capability growth and adaptation to specific deployment requirements.

A general object of this invention provides advance warning of an impending collision which gives workers and individuals time to react and get out of harm's way to save lives and minimize injuries.

Another object of the invention is to provide specially designed image sensors to classify the moving object and determine if it could cause harm, which triggers a warning of impending harm in real-time.

Yet another object of the invention is to provide a system to detect, track, measure and identify moving objects all in one system.

Still another object of the invention is no need for any auxiliary hardware, such as active sensors, to sense an intrusion.

Another object of the invention is in the use of image formation such as roads, cones, road lines and similar items to calibrate and optimize the system in real-time.

Another object of the invention is to measure distance and trajectory of a moving image, to obtain a speed measurement to predict the location of an object over time. This is not the motion detection system described in White.

Yet another object of the invention is to provide a method to sense irregular or dangerous traffic patterns and a complimentary method to output these patterns to another system for interaction with ongoing traffic and workers.

Another object of the invention is to provide a multiple stage sensing device with an interactive system that will output multiple warning triggers based on direction, speed and combination of direction and speed.

Still another advantage of the invention is to provide a small device that utilizes a neural network to recognize objects for the purpose of traffic pattern recognition and operates as a stand-alone device.

Another object of the invention is to provide a light bar mounted sensor that utilizes artificial intelligence to recognize impending danger and alerts people.

Yet another object of the invention is to provide a system used for traffic safety warnings that utilizes artificial intelligence to alert workers and drivers of irregular patterns.

Yet another object of the invention is to provide the capability to warn both the motoring public, as well as individuals in a work zone or hazardous situation, simultaneously, in real time, that a potential hazard may occur.

Another object of the invention is to provide a Zone Communication system that identifies a potentially hazardous situation and activates a warning message that is displayed on the pavement. This lighted message on the roadway warns drivers of a dangerous situation ahead.

### SUMMARY OF THE INVENTION

The present invention provides a comprehensive moving objects sensing device and intrusion detection system designed to prevent collisions and protect personnel in roadway work zones, emergency vehicle locations, and other hazardous traffic situations. The system represents a significant advancement over prior art by utilizing passive image capture technology combined with local artificial intelligence processing to detect, classify, track, and predict object trajectories without requiring active sensors or internet connectivity.

At its core, the invention comprises an integrated sensing device featuring a camera and central processing unit configured with artificial intelligence to capture images of stationary or moving objects within a specified area. The CPU employs neural networks trained on custom models to calculate mass, motion, and trajectory of detected objects in real-time. When the system predicts that an object will enter the protected area and poses a danger, it generates voltage signal outputs to activate audible alert indicators, visual alert indicators, and haptic alert devices, providing workers and drivers with advance warning of potentially unsafe situations, intrusions, or collisions. The system is specifically designed to alert workers in work zones containing emergency, construction, or road maintenance equipment and personnel.

The device configuration represents a modular and flexible architecture housed in a single integrated unit. The system features a monocular camera, central processing unit, and wireless communication capabilities that can be mounted on fixed locations including poles and sign boards, or attached to vehicles. A key innovation is the device's ability to function effectively in both stationary and mobile applications, maintaining accurate detection and tracking whether deployed at a fixed work zone or mounted on a moving vehicle. The system is expandable, allowing for the addition of a second camera to create stereoscopic vision for enhanced depth perception and distance measurement, or the integration of doppler radar devices for supplementary velocity measurements and added features.

The artificial intelligence component distinguishes this invention from prior art systems. The device employs neural network algorithms executed locally on the CPU without requiring internet connectivity, utilizing specialized hardware for real-time processing. The AI is trained using custom models specifically designed to detect vehicles and classify object types relevant to roadway safety, including various vehicle types, traffic cones, painted street lines, barrels, and other safety equipment. The system calibrates object detection using static features in captured images such as road markings, traffic cones, and road signs to optimize distance and size calculations. This targeted training approach enables highly accurate classification while reducing false positives that compromise less sophisticated systems.

The invention implements sophisticated traffic analysis and warning capabilities beyond simple object detection. The system identifies vehicles approaching work zones and determines their direction of travel, travel lane, and speed. By analyzing these factors, the device determines safe versus unsafe traffic patterns and generates warnings when approaching vehicles are in unsafe travel lanes traveling at speeds calculated to be unstoppable before impact. The system provides multiple staged warnings based on different threshold distance thresholds, activating first warnings when objects reach initial distance thresholds and second warnings at closer thresholds. The device simultaneously triggers haptic alert devices worn by workers, visual displays on signage, and audible warning devices positioned throughout the specified area. Additionally, the system detects irregular traffic patterns including erratic vehicle movements and can output pattern data to traffic management systems. The device is also capable of comprehensive traffic data collection including vehicle counts, average speeds, types of vehicles, and direction of traffic flow.

The invention's versatility extends to diverse deployment scenarios. Beyond traditional work zone applications, the device is configured for use in aeronautic applications mounted on drones to monitor traffic, traffic direction, and personnel from aerial vantage points. When unsafe patterns are detected, the system sends alerts to notify people on the ground of potential hazards. The system also recognizes changes in safety equipment patterns, such as when traffic cones or barrels in work zones are run over or knocked over by vehicles, automatically generating alert signals to warn workers of compromised safety perimeters. The wireless communication capabilities, including Bluetooth, WiFi, and cellular connectivity, enable transmission of alerts to remote devices, allowing for comprehensive notification systems. The integration of GPS sensing and acceleration sensing capabilities provides location and motion data for precise object detection calibration. Through continuous machine learning, the artificial intelligence improves object detection accuracy over time by analyzing captured images, ensuring the system becomes increasingly effective throughout its operational life.

Other objects, features and advantages of the present invention will be apparent when the detailed description of the preferred embodiments of the invention are considered with reference to the drawings, which should be construed in an illustrative and not a limiting sense.

### BRIEF DESCRIPTION OF THE DRAWINGS

FIG. 1 is an illustration of the component parts of the invention; and

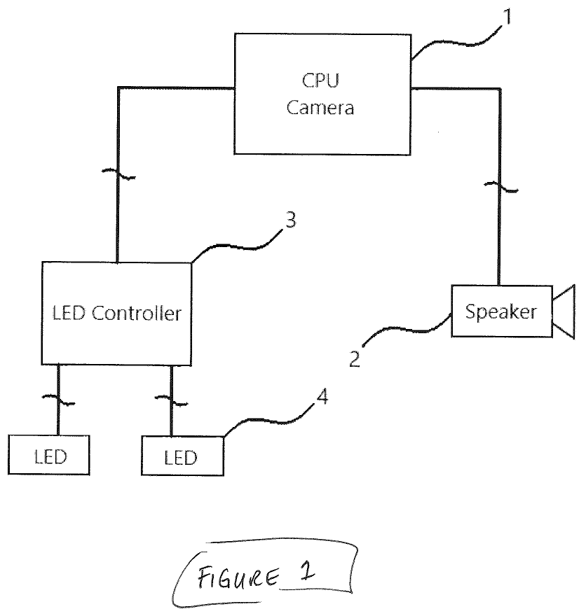

FIG. 2 is an illustration of another embodiment of the component parts of the invention.

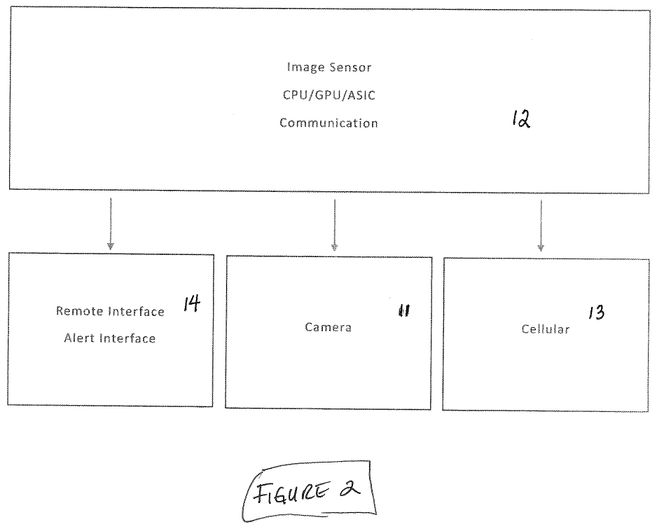

### DETAILED DESCRIPTION OF THE INVENTION

As used in the specification herein and as illustrated in the drawings the following numerals refer to the respective structures:
1—integrated image capture device including CPU and camera;
2—audible alarm device, i.e. siren or speaker
3—light emitting diode (LED) controller
4—LED
11—camera
12—image senor/CPU communication
13—cellular
14—remote interface/alert interface

In general, the present invention provides a sensing device for integrated image capture of moving and/or stationary objects in a specified area.

The invention also provides related intrusion detection systems specifically designed for roadway safety applications. The system addresses critical safety needs in work zones, emergency vehicle scenarios, and other traffic situations where workers and personnel face collision risks from approaching vehicles. Unlike prior art systems that rely on active sensors requiring signal transmission or internet connectivity, this invention utilizes passive image capture combined with local artificial intelligence processing to provide reliable, real-time collision warnings.

### System Architecture and Hardware Components

The sensing device comprises several integrated hardware components configured to work in concert to detect, analyze, and alert. The primary components include:
Camera System: The device features a monocular camera capable of capturing moving images within a specified area. The camera operates as a passive sensor that captures ambient light without transmitting active signals, distinguishing it from systems using ultrasonic, LIDAR, or other active sensing technologies. The passive operation eliminates issues with signal interference, environmental reflections, and the limitations of active sensors in heavy traffic or partial occlusion scenarios.

The camera system is expandable through a modular architecture. A second camera can be added to the single housing to convert the monocular configuration into a stereoscopic camera unit. Stereoscopic vision provides enhanced depth perception and more accurate distance measurements through parallax calculations, improving trajectory prediction accuracy. The dual-camera configuration enables the system to better resolve objects at varying distances and provides redundancy in challenging lighting conditions.

Central Processing Unit: The CPU represents the computational core of the system, executing multiple critical functions. The processor is configured with artificial intelligence capabilities, specifically neural network algorithms optimized for object detection, classification, and tracking. The CPU includes specialized hardware such as Application-Specific Integrated Circuits (ASICs) and Graphics Processing Units (GPUs) that enable local AI processing without requiring external servers or internet connectivity. This local processing approach provides several advantages: reduced latency for real-time alerts, elimination of network dependency, improved reliability in areas with poor connectivity, and enhanced data privacy since images are not transmitted externally.

The CPU calculates mass and motion characteristics of detected objects by analyzing sequential image frames. Through computer vision techniques, the processor determines object size, speed, direction, and acceleration. These parameters feed into trajectory prediction algorithms that calculate whether detected objects will enter the protected area and the time-to-impact if collision course is maintained. The processor simultaneously tracks multiple objects, distinguishing between them based on size, speed, and trajectory to determine relative collision risk levels and prioritize warnings accordingly.

GPS and Acceleration Sensing: The CPU integrates GPS sensing and acceleration sensing capabilities that provide critical calibration data. GPS coordinates establish the device's geographic location, enabling accurate mapping of the protected area and surrounding approach zones. The acceleration sensors detect device movement, allowing the system to function effectively when mounted on moving vehicles. When in mobile deployment, the acceleration data enables the system to compensate for device motion in its trajectory calculations, ensuring accurate predictions regardless of platform movement.

Wireless Communication: The device includes comprehensive wireless communication capabilities encompassing Bluetooth, WiFi, and cellular connectivity. These communication channels enable multiple functions: transmission of alerts to remote devices including smartphones, tablets, and wearable safety equipment; coordination with other safety systems and traffic management infrastructure; remote configuration and monitoring of system parameters; and transmission of collected traffic data for analysis and reporting.

Doppler Radar Integration: The system architecture supports the addition of doppler radar devices that work in conjunction with the camera system. Doppler radar provides independent velocity measurements and distance data that complement the image-based analysis. The fusion of radar and vision data enhances overall system accuracy, particularly in challenging conditions such as low visibility, precipitation, or high-speed scenarios where redundant measurements improve reliability.

Single Housing Design: All components are integrated within a single housing that provides environmental protection and facilitates installation. The housing is designed for mounting on various platforms including fixed locations such as poles and sign boards, or mobile platforms such as vehicles. The compact, integrated design simplifies installation, reduces cabling complexity, and provides a weatherproof enclosure suitable for outdoor deployment in harsh conditions.

### Artificial Intelligence and Image Processing

The artificial intelligence component represents a core innovation of the invention, providing capabilities far exceeding conventional motion detection systems. The AI implementation consists of several layers:

Network Architecture: The system employs deep neural networks specifically architected for real-time object detection and classification. The neural network is trained using a custom model developed specifically for roadway safety applications rather than general-purpose object recognition. This specialization enables highly accurate detection of vehicles, traffic safety equipment, and relevant objects while minimizing false positives from irrelevant environmental features.

Custom Training Model: The training process uses carefully curated datasets containing vehicles of various types (cars, trucks, tractors, motorcycles, construction equipment), traffic control devices (cones, barrels, signs, barriers), road features (painted lines, lane markers, pavement patterns), and relevant roadway objects. The model is trained to recognize these objects across varying conditions including different lighting, weather, viewing angles, and partial occlusions. The training emphasizes classification accuracy for objects capable of causing harm versus benign environmental features, ensuring the system focuses computational resources on genuine threats.

The training methodology incorporates transfer learning techniques, starting with established neural network architectures and refining them through additional training on the specialized roadway safety dataset. This approach leverages proven network designs while adapting them to the specific detection requirements of the application. The model achieves high accuracy in vehicle classification, distinguishing between vehicle types and sizes that correlate with different threat levels.

Local AI Processing: Unlike systems requiring cloud-based processing, this invention executes all neural network computations locally on the device. The CPU's specialized hardware (ASICs/GPUs) provides sufficient computational power for real-time inference, processing video frames at rates sufficient for responsive collision warnings. Local processing eliminates network latency that could delay critical alerts and ensures system operation even without internet connectivity. The processing pipeline operates continuously, analyzing each captured frame through the neural network to detect and classify objects.

Object Detection and Tracking: The AI system performs multi-object detection and tracking across sequential frames. For each detected object, the system establishes a track that persists across frames, enabling velocity and trajectory calculations. The tracking algorithms handle objects moving through various portions of the image, maintaining identity even during brief occlusions or when multiple objects cross paths. Track maintenance enables accurate speed calculations by measuring object displacement across known time intervals.

Image Calibration: The system implements automatic calibration using static features visible in captured images. Road markings, traffic cones arranged in known patterns, road signs, and other fixed references provide geometric information about the scene. The AI analyzes these features to establish spatial relationships between image pixels and real-world distances. This calibration process adapts automatically to different camera mounting heights, angles, and focal lengths, enabling accurate distance and size measurements without manual configuration. The calibration data feeds into the trajectory prediction algorithms, ensuring accurate calculations of object positions, velocities, and predicted paths.

Pattern Recognition: Beyond individual object detection, the AI recognizes spatial patterns of safety equipment. The system learns typical arrangements of traffic cones, barrels, and barriers in work zone configurations. By recognizing these patterns, the device can detect when safety equipment has been displaced, knocked over, or run over by vehicles. Pattern changes trigger alert signals warning workers that the protective perimeter has been compromised and the work zone layout may be unsafe.

Continuous Learning: The AI incorporates machine learning capabilities that enable continuous improvement. As the system operates, it analyzes captured images to refine detection accuracy. The learning process identifies objects that were initially missed or misclassified and adjusts network parameters to improve future performance. This adaptive capability ensures the system becomes increasingly effective over its operational lifetime, learning to handle site-specific conditions and unusual scenarios encountered in actual deployment.

### Trajectory Prediction and Collision Analysis

The core safety function of the system depends on accurate trajectory prediction and collision risk assessment:

Trajectory Calculation: For each tracked object, the system calculates mass and motion characteristics including position, velocity vector, and acceleration. The trajectory prediction algorithm projects the object's future path based on current motion parameters. The prediction incorporates kinematic models that account for typical vehicle behavior, including momentum, turning radii, and deceleration capabilities. The algorithm generates predicted position as a function of time, enabling calculation of when (or if) the object will reach various distance thresholds.

Safe Pattern Determination: The system analyzes traffic patterns to distinguish safe from unsafe vehicle behaviors. In work zone applications, the device identifies designated travel lanes where vehicles should pass safely versus lanes that would cause vehicles to impact the protected area. The system determines appropriate vehicle speeds for safe passage based on distance to the work zone and typical stopping distances. By comparing detected vehicle positions and velocities against these safety parameters, the device determines whether approaching vehicles are following safe traffic patterns or deviating into dangerous trajectories.

Travel Lane Analysis: For vehicles approaching work zones, the system determines specific travel lanes by analyzing vehicle positions relative to visible road markings and lane boundaries. The AI identifies painted lane lines, road edges, and lane divisions to establish a coordinate system for vehicle positions. By determining which lane a vehicle occupies and comparing that lane to the designated safe passage lanes, the system detects vehicles that have drifted into lanes that will cause work zone intrusion.

Speed Analysis: The system measures vehicle speeds by tracking position changes across sequential frames at known frame rates. These speed measurements are compared against calculated safe speeds based on distance to the work zone and typical vehicle stopping distances. The stopping distance calculation incorporates factors such as vehicle size (which correlates with mass and momentum), approach speed, and distance remaining. When a vehicle's speed exceeds what can safely stop before reaching the protected area, the system classifies the situation as high risk.

Time-to-Impact Calculation: The trajectory prediction algorithm calculates time-to-impact values indicating how many seconds remain before a detected object will reach the protected area boundary. This calculation combines position, velocity, and predicted trajectory to provide precise timing information. The time-to-impact value determines warning urgency and triggers staged alerts at appropriate intervals.

Multiple Threshold Distances: The system implements multiple distance thresholds that trigger progressively more urgent warnings. A first distance threshold, positioned relatively far from the protected area, triggers initial warnings when vehicles on collision trajectories reach this boundary. This early warning provides maximum time for workers to react and seek safety. A second, closer distance threshold triggers more urgent warnings with heightened intensity when immediate danger is imminent. Additional threshold distances can be configured for multi-stage warning systems with three or more progressive alert levels.

Multi-Object Risk Assessment: When tracking multiple objects simultaneously, the system prioritizes threats based on calculated collision risk. Objects with higher approach speeds, trajectories directly toward the protected area, and shorter time-to-impact values receive higher priority. The prioritization ensures alert systems respond to the most imminent threats first while still providing warnings for lower-priority risks. The system can simultaneously generate different alert types for different threat levels, providing workers with information about the overall risk environment.

Irregular Pattern Detection: Beyond detecting objects on collision courses, the system identifies irregular traffic patterns that may indicate dangerous conditions. Erratic vehicle movements such as swerving, sudden acceleration or deceleration, and irregular steering patterns are detected through analysis of trajectory variations. These irregular patterns may indicate impaired drivers, vehicle malfunctions, or other dangerous conditions even before vehicles reach critical distances. Early detection of irregular patterns enables preemptive warnings.

### Alert Systems and Warning Mechanisms

The device activates multiple alert mechanisms to warn workers and drivers of detected dangers:

Voltage Signal Generation: When the system determines a warning should be issued, it generates voltage signal outputs on specified electrical connections. These signals follow industry-standard interfaces enabling activation of various warning devices. The voltage signals can directly drive simple indicators or interface with more complex alert systems through standard protocols.

Audible Alert Indicators: The system activates audible warning devices to alert personnel through sound. Audible alerts can include sirens, horns, speakers producing recorded messages, or other sound-generating devices. The device configures alerts to emit warning sounds at decibel levels sufficient to alert workers within the specified area even in high-ambient-noise environments typical of construction and roadway settings. The audible alerts can be modulated in intensity, frequency, or pattern to convey different warning levels corresponding to threat urgency.

Visual Alert Indicators: The system activates visual alert indicators to provide warnings through light. A visual alert implementation utilizes an LED controller connected to a plurality of LEDs or other light-emitting devices arranged in patterns visible to both approaching vehicles and workers in the protected area. The LED arrangements can include arrow boards, warning message signs, flashing light bars, or strobing lights. The visual indicators operate at sufficient intensity for visibility in bright daylight conditions and can be programmed with different flash patterns or colors to convey various warning types.

For approaching drivers, the visual alerts provide advance notification that they are approaching a work zone on an unsafe trajectory, potentially enabling driver correction before impact. For workers, the visual alerts provide directional information about threat approach directions, enabling workers to move away from danger.

Haptic Alert Indicators: The system supports haptic alert devices that provide tactile feedback to workers. Haptic devices can include vibrating units worn on workers'belts, wrists, or other body locations, or integrated into safety vests. When the system detects dangerous conditions, it transmits wireless signals to activate these personal haptic alerts, ensuring workers receive warnings even if audible or visual alerts are missed due to noise, visual obstructions, or worker orientation.

Simultaneous Multi-Modal Alerts: To ensure maximum warning effectiveness, the system typically activates multiple alert types simultaneously. A typical activation sequence includes simultaneously triggering haptic devices worn by workers, activating visual displays on signage and arrow boards, and sounding audible warning devices positioned throughout the protected area. This redundant, multi-sensory approach maximizes the probability that all personnel receive and respond to warnings regardless of individual circumstances.

Remote Device Alerts: Through wireless communication channels, the system transmits alert signals to remote devices including smartphones, tablets, smartwatches, and specialized safety equipment carried by workers or supervisors. These remote alerts can include visual notifications, audible tones, haptic vibrations, and data messages describing the nature and location of detected threats. Remote alerts enable personnel not directly in the work zone to be informed of dangerous conditions, supporting coordination and emergency response.

Traffic Management System Integration: The device outputs detected traffic pattern data to traffic management systems through network connections. This integration enables coordination with intelligent transportation systems, traffic signal control, and broader infrastructure safety systems. By sharing data about irregular patterns, high-risk vehicle behaviors, and actual intrusion events, the device contributes to regional traffic safety management.

### Deployment Configurations and Operational Modes

The device supports diverse deployment configurations adapted to various safety scenarios:

Fixed Work Zone Deployment: In traditional work zone applications, the device mounts on fixed infrastructure within or adjacent to the protected area. Mounting locations include poles placed at work zone perimeters, arrow boards that provide directional guidance, or dedicated sign boards positioned for optimal field of view. The camera aims to capture approaching traffic in lanes that could impact the work zone. In fixed deployment, the system calibrates using static scene features and operates continuously to monitor approach lanes.

The system determines safe travel patterns based on work zone layout, identifying which lanes permit safe passage and which lanes will cause intrusion. For emergency vehicles, construction operations, and road maintenance activities, the system provides continuous protection, alerting workers to approaching vehicles before they enter the danger zone.

Mobile Vehicle Deployment: The device mounts on vehicles including emergency response vehicles, mobile construction equipment, maintenance trucks, and utility vehicles. When mounted on moving vehicles, the system functions in mobile mode where the device itself is in motion along with the protected personnel. The acceleration sensors detect platform motion, and the processor compensates for vehicle movement in trajectory calculations.

For emergency vehicles stopped on highways, the device provides critical protection for personnel working around the vehicle. The system detects approaching traffic in adjacent lanes and warns both the personnel and approaching drivers when vehicles fail to move over or slow down as required by move-over laws. The early warning enables personnel to take evasive action before vehicles reach the emergency vehicle location.

Aeronautic/Drone Deployment: The device is configured for mounting on unmanned aerial vehicles (drones) for elevated monitoring perspectives. Aerial deployment provides wide area coverage and unobstructed views of traffic patterns. The system monitors traffic flow, direction, and personnel positions from above, detecting unsafe patterns such as vehicles entering closed lanes or approaching personnel from unexpected directions.

When unsafe patterns are detected from the aerial vantage point, the system transmits alerts to ground-based receivers, warning personnel of approaching dangers they may not see from ground level. Aerial deployment is particularly valuable in complex work zones with multiple work areas, limited sight lines, or situations where ground-based sensors would have obstructed views.

Multi-Device Coordination: Multiple devices can be deployed in coordinated networks, sharing detection data and alert status to provide comprehensive coverage of large work zones. Coordinated devices communicate wirelessly, enabling handoff of tracked objects as vehicles move between device coverage areas and ensuring continuous monitoring without gaps.

### Data Collection and Analysis Capabilities

Beyond immediate safety functions, the device provides valuable data collection:

Traffic Data Collection: The system continuously collects traffic data including vehicle counts, average speeds, speed distributions, types of vehicles (classified by the AI), and direction of traffic flow. This data is stored locally and can be transmitted to remote systems for analysis. Traffic data collection enables work zone traffic impact assessment, identification of peak traffic periods, evaluation of traffic control effectiveness, and long-term traffic pattern analysis.

Pattern Analysis and Reporting: Detected irregular traffic patterns, near-miss events, and actual intrusions are logged with timestamps, video evidence, and contextual data. These records provide valuable information for safety analysis, infrastructure planning, and incident investigation. The pattern data can reveal systematic problems with work zone layout, signage effectiveness, or traffic control measures.

Performance Monitoring: The system logs operational data including detection rates, alert activations, and system health parameters. This data supports maintenance planning, performance optimization, and validation of system effectiveness.

### Detailed Component Specifications

Camera Specifications: The camera employs high-resolution image sensors capable of capturing detail sufficient for vehicle recognition at operationally relevant distances. Frame rates are sufficient for smooth tracking and accurate velocity calculations, typically ranging from 30 to 60 frames per second. The camera optics are selected to provide appropriate field of view for the intended deployment, with focal lengths chosen to balance coverage area against recognition detail. Weather-resistant housings with automatic heating (for cold environments) or cooling (for hot environments) ensure reliable operation across temperature extremes.

CPU and Processing Hardware: The central processing unit incorporates specialized AI acceleration hardware including neural network ASICs optimized for inference operations, GPUs with high parallel processing throughput for image processing and neural network operations, and general-purpose processor cores for system management, communication, and coordination tasks. Sufficient memory capacity supports neural network model storage, frame buffering for multi-frame tracking, and data logging. Storage includes non-volatile memory for system firmware, AI models, configuration data, and local data logging.

Power Systems: The device supports multiple power options including direct vehicle power connections (typically 12V or 24V DC), AC power adapters for fixed installations, and battery backup for autonomous operation. Power management circuitry ensures stable operation across voltage variations and provides protection against electrical transients common in vehicle and roadway environments.

Communication Interfaces: Wireless communication modules support Bluetooth for short-range connections to personal devices, WiFi for local network connectivity and higher-bandwidth data transfer, and cellular modems for wide-area connectivity and remote access. Wired communication interfaces support direct connections to alert devices, other system components, and external equipment. Interface protocols include industry-standard options such as CAN bus (common in vehicle systems), RS-232/RS-485 serial interfaces, and Ethernet for network integration.

Environmental Protection: The housing provides protection rated for outdoor deployment, typically IP65 or better, ensuring resistance to dust, water spray, and environmental contaminants. Materials are selected for UV resistance, temperature tolerance, and durability under mechanical stress. Mounting hardware supports secure attachment to various platform types.

### Operational Parameters and Configurations

Distance Thresholds: The system supports configurable distance thresholds typically ranging from 50 to 500 meters depending on deployment scenario. Highway deployments with high-speed traffic use longer distances, while lower-speed work zones use shorter distances. Multiple threshold distances are configured with typical spacing of 50-100 meters between thresholds.

Alert Escalation: Alert intensity escalates as threats progress through distance thresholds, with initial alerts being less intrusive (single tones, steady lights) and final alerts being highly conspicuous (continuous sirens, rapidly flashing lights, vigorous haptic vibrations).

Vehicle Classification: The AI classifies detected vehicles into categories including passenger cars, pickup trucks, vans, commercial trucks, buses, motorcycles, and specialized vehicles. Classification enables threat assessment based on vehicle type, as larger vehicles pose greater impact risks.

Speed Thresholds: Configurable speed thresholds define unsafe speeds for various distances, typically based on stopping distance calculations. Vehicles exceeding these thresholds at corresponding distances are flagged as high risk.

Protected Area Definition: The system defines protected areas through various methods including GPS coordinate boundaries (for mobile deployments), image-based regions (for fixed deployments), or distance-based zones (simple radius around device). Protected area configuration adapts to work zone layout and operational requirements.

Sensitivity and Filtering: Configurable sensitivity parameters balance detection responsiveness against false positive rates. Filtering parameters eliminate nuisance alerts from distant vehicles clearly on safe trajectories while ensuring genuine threats are never missed.

### EXAMPLES OF OPERATIONAL SCENARIOS

### Scenario 1

Highway Work Zone: A road construction crew is performing lane striping on a three-lane highway. Two lanes are closed for the work, with traffic directed through the remaining open lane. Multiple devices are deployed on arrow boards at the work zone perimeter, monitoring the closed lanes for intrusions. The AI detects vehicles in the open lane and verifies they maintain safe trajectories. When a distracted driver drifts into a closed lane at 65 mph, the system immediately detects the intrusion vector, calculates the vehicle will impact the work zone in 8 seconds, and activates all alert mechanisms. Workers hear sirens, see flashing lights, feel haptic vibrations, and move to safety. The visual alerts also catch the driver's attention, who corrects course before reaching the work zone.

### Scenario 2

Emergency Vehicle on Highway Shoulder: A police vehicle is stopped on the highway shoulder assisting a motorist. The officer is standing beside the disabled vehicle in the high-visibility zone adjacent to traffic lanes. The detection device mounted on the police vehicle monitors approaching traffic. The system detects that most vehicles are moving over or slowing down as required. When a vehicle approaches at high speed in the lane nearest the shoulder without moving over, the system alerts the officer through audible warnings from the vehicle speaker and haptic alerts on the officer's safety vest. The officer steps behind the disabled vehicle moments before the approaching vehicle passes dangerously close.

### Scenario 3

Work Zone Safety Perimeter Breach: A maintenance crew is working behind a barrier formed by traffic cones and barrels. The device monitors both approaching traffic and the safety perimeter equipment. When an erratic driver side-swipes the barriers, knocking over multiple cones, the system detects the pattern change immediately. The AI recognizes the work zone perimeter has been compromised before the vehicle actually enters the work area. Workers receive immediate alerts about the barrier breach and move to safer positions while the vehicle corrects course and exits the area.

### Scenario 4

Drone-Monitored Complex Work Zone: A large construction site spans multiple lanes with several work areas. A drone-mounted device provides aerial monitoring. The system tracks all traffic through and around the construction zone, identifying safe traffic patterns. When a delivery truck enters a prohibited lane attempting to access one work area, the system detects the unusual pattern, determines the truck will reach workers in 15 seconds, and transmits alerts to ground-based receivers worn by crews in that area. Workers clear the area while traffic control personnel redirect the truck.

### Scenario 5

Data Collection for Traffic Study: Over a two-week period, a device deployed at a work zone collects comprehensive traffic data. The data reveals that average speeds increase significantly during certain hours, and that larger commercial vehicles frequently enter unsafe lanes during evening hours. This analysis prompts traffic engineers to enhance signage, adjust lane closure timing, and increase enforcement during problematic periods, significantly improving work zone safety.

### Operational Considerations

Lighting Conditions: The device operates effectively across diverse lighting conditions including bright sunlight, overcast conditions, dawn/dusk twilight, and nighttime. The camera's dynamic range and AI training across varied lighting enable reliable detection regardless of illumination. For nighttime operation, the system leverages vehicle headlights illuminating the scene, with detection algorithms trained on nighttime vehicle appearance.

Weather Performance: The system maintains operation during adverse weather including rain, snow, and fog. While detection range may be reduced in heavy precipitation or dense fog, the AI training includes these conditions, enabling continued operation at reduced ranges. The multi-modal sensor approach with optional radar integration provides redundancy when vision-based detection is compromised.

Installation and Calibration: Installation requires physical mounting, power connection, and communication setup. After installation, the system performs automatic calibration using visible scene features, minimizing setup time. For fixed installations, one-time calibration establishes scene geometry. For mobile installations, the system continuously recalibrates as the vehicle moves to new locations.

Maintenance: The system requires minimal maintenance, primarily limited to periodic cleaning of the camera lens to maintain image quality and occasional firmware updates to refine AI models and add features. Solid-state design with no moving parts ensures reliability. Status monitoring identifies component failures or degraded performance, enabling predictive maintenance.

The moving objects sensing device and intrusion detection system provides comprehensive protection for workers and personnel in roadway environments through advanced AI-based threat detection and multi-modal alerting. The combination of passive sensing, local processing, trajectory prediction, and versatile deployment options creates a system superior to existing technologies in reliability, responsiveness, and effectiveness. The device advances roadway safety technology, providing critical seconds of warning time that enable personnel to avoid injury and save lives in work zones, emergency situations, and other hazardous roadway environments.

The foregoing description of various and preferred embodiments of the present invention has been provided for purposes of illustration only, and it is understood that numerous modifications, variations and alterations may be made without departing from the scope and spirit of the invention as set forth in the following claims.

1. A sensing device for integrated image capture of an object, that is stationary or moving, for use in an intrusion detection system for roadways comprising:
a camera and a central processing unit (CPU) configured to capture said image within a specified area, wherein said CPU is configured with artificial intelligence to calculate mass and motion of an object in said image and predict a trajectory of said object;
an audible alert indicator connected to said integrated image capture device; and
a visual alert indicator connected to said integrated image capture device;
wherein said audible alert indicator and said visual alert indicator are activated to send a voltage signal output when said object is predicted to enter said specified area to alert workers and drivers in the specified area of a dangerous situation, intrusion or collision.

2. The intrusion detection system according to claim 1, further comprising a haptic alert indicator configured to provide tactile feedback to workers when said object is predicted to enter said specified area.

3. The intrusion detection system according to claim 1, wherein said audible alert indicator is configured to emit a warning sound at a decibel level sufficient to alert workers within said specified area.

4. The intrusion detection system according to claim 1, wherein said visual alert indicator activates an LED controller connected to a plurality of LEDs, or other light emitting devices arranged in a pattern visible to approaching vehicles and workers.

5. The intrusion detection system according to claim 1, wherein said artificial intelligence comprises a neural network trained on a custom model to detect and classify vehicles as objects capable of causing harm.

6. The intrusion detection system according to claim 1, wherein said CPU further comprises GPS sensing and acceleration sensing capabilities configured to provide location and motion data for calibrating object detection.

7. The intrusion detection system according to claim 1, wherein said integrated image capture device operates as a passive sensor that captures light without transmitting active signals.

8. The intrusion detection system according to claim 1, wherein said specified area comprises a work zone with emergency, construction, road maintenance equipment and personnel, and said system is mounted on signage or vehicles within said work zone.

9. The intrusion detection system according to claim 1, further comprising wireless communication capability selected from the group consisting of Bluetooth, WiFi, and cellular connectivity for transmitting alerts to remote devices.

10. The intrusion detection system according to claim 1, wherein said CPU is configured to track multiple objects simultaneously and distinguish between objects based on size, speed, and trajectory to determine collision risk levels.

11. A method for detecting approaching objects and preventing collisions in roadway areas comprising:
capturing a moving image within a specified area using a camera connected to a central processing unit (CPU);
processing said moving image using artificial intelligence to identify and classify objects within said moving image;
calculating mass, motion and pattern characteristics of identified objects to predict trajectories;
determining whether any predicted trajectory will cause an object to enter said specified area;
generating alert signals when an object is predicted to enter said specified area; and
activating an audible and a visual alert indicators to warn workers and drivers in said specified area of a potential collision.

12. The method according to claim 11, further comprising training said artificial intelligence using a custom model specifically designed to detect vehicles and classify object types relevant to roadway safety.

13. The method according to claim 11, wherein said processing step utilizes neural network algorithms executed locally on said CPU without requiring internet connectivity.

14. The method according to claim 11, further comprising calibrating object detection using static features in said moving image including road markings, traffic cones, and road signs to optimize distance and size calculations.

15. The method according to claim 11, wherein said calculating step includes measuring distance and speed of objects to generate time-to-impact predictions for collision warnings.

16. The method according to claim 11, further comprising providing multiple staged warnings based on different threshold distances, wherein a first warning is activated when an object reaches a first distance threshold, and a second warning is activated when said object reaches a closer second distance threshold.

17. The method according to claim 11, wherein said activating step includes simultaneously triggering haptic alert devices worn by workers, visual displays on signage, and audible warning devices positioned throughout said specified area.

18. The method according to claim 11, further comprising detecting irregular traffic patterns including erratic vehicle movements and outputting pattern data to traffic management systems.

19. The method according to claim 11, wherein said specified area comprises an emergency vehicle stopped on a street or highway, and said method provides advance warning to protect emergency personnel.

20. The method according to claim 11, further comprising continuously updating said artificial intelligence through machine learning by analyzing captured images to improve object detection accuracy over time.

21. A moving objects sensing device comprising a monocular camera, a central processing unit, and wireless communication in a single housing, said device configured to be mounted to a fixed location on a vehicle or a permanent fixed object selected from the group consisting of poles and sign boards, wherein said device is designed to function in either a fixed or moving application and is configured to detect an object and identify the type of object using an algorithm incorporating artificial intelligence.

22. The moving objects sensing device according to claim 21, wherein said device is capable of adding an additional camera to said single housing, thereby converting said monocular camera into a stereoscopic camera unit for enhanced depth perception and distance measurement.

23. The moving objects sensing device according to claim 21, wherein said device is capable of adding a doppler radar device to work in conjunction with said monocular camera for providing additional velocity and distance measurement features.

24. The moving objects sensing device according to claim 21, wherein said device is used to identify a vehicle approaching a work zone, and said algorithm is configured to determine the direction of travel, travel lane, and speed of said approaching vehicle.

25. The moving objects sensing device according to claim 21, wherein said device is designed to determine a safe pattern of travel in a work zone situation, and wherein said device generates a voltage signal output to activate a warning device when said device determines that an approaching vehicle is in an unsafe travel lane and traveling at a speed calculated to be unstoppable before impact to said device.

26. The moving objects sensing device according to claim 21, wherein said warning device is selected from the group consisting of visual warning devices, audible warning devices, and haptic warning devices, said warning being designed to alert workers that a potentially unsafe situation exists and allow them time to react.

27. The moving objects sensing device according to claim 21, wherein said device is designed to determine traffic patterns either approaching or moving away, and wherein said device generates a voltage signal output to activate a warning device based upon direction of travel when that direction is deemed to be dangerous.

28. The moving objects sensing device according to claim 21, wherein said device is capable of traffic data collection including vehicle counts, average speeds, types of vehicles, and direction of traffic flow.

29. The moving objects sensing device according to claim 21, wherein said device is configured for use in an aeronautic application mounted on a drone to monitor traffic, traffic direction, and personnel to determine if an unsafe pattern is present, and send an alert to notify people on the ground of a potential hazard or unsafe situation.

30. The moving objects sensing device according to claim 21, wherein said device is capable of recognizing various types of objects selected from the group consisting of vehicles, traffic cones, painted street lines, and barrels, and wherein said device is configured to determine that a pattern of these objects has been established or changed, wherein a change in the object pattern initiates an alert signal from said device to warn workers when traffic cones or barrels in a work zone have been run over or knocked over by a vehicle.
